(19) United States
(12) Patent Application Publication
(10) Pub. No.: US 2017/0275784 A1
(43) Pub. Date: Sep. 28, 2017

(54) IGNITION RESISTANT COTTON FIBERS

(71) Applicant: Carbtex Technology, Inc., Angleton, TX (US)

(72) Inventor: Francis P. McCullough, Angleton, TX (US)

(21) Appl. No.: 15/621,599

(22) Filed: Jun. 13, 2017

Related U.S. Application Data
(63) Continuation-in-part of application No. 14/703,514, filed on May 4, 2015.
Application No. 14/703,514 is a continuation-in-part of application No. 14/071,432, filed on Nov. 4, 2013.
(60) Provisional application No. 62/349,989, filed on Jun. 14, 2016.

(51) Int. Cl. D01F 1/07; D21H 21/34; D21H 17/60

(52) U.S. Cl. CPC D01F 1/07; D21H 17/60; D21H 21/34; B32B 2307/3065

(57) ABSTRACT

A bi-regional fiber with a cellulosic core and a wax outer sheath is disclosed. The sheath can comprise high melting temperature wax. The fiber may be produced by processing the natural fiber at temperatures less than 70° C. The fiber can be processed in a standard manner such as, for example, a Keir process which may include bleach at approximately 100° C. with a wax subsequently added at a temperature sufficient to disperse the wax over the fiber surface. The fibers are ignition resistant as measured by industry standard tests. The wax may comprise from about 0.4 to 25 percent or greater of the fiber by weight. The wax may be natural wax, synthetic or emulsified wax or blends thereof. The bi-regional fibers can be blended with other fibers including BRCF fibers to create fire resistant fabrics including clothing, blankets and household materials.

### REFERENCE TO RELATED APPLICATION

This application claims priority to U.S. Provisional Application No. 62/349,989 entitled “Ignition Resistant Cotton Fibers” filed Jun. 14, 2016. This application is also a continuation-in-part of U.S. application Ser. No. 14/703,514 entitled “Articles of Ignition Resistant Cotton Fibers” filed May 4, 2015, which is a continuation-in-part of U.S. application Ser. No. 14/071,432 entitled “Novel Ignition Resistant Cotton Fiber, Articles made from Ignition Resistant Cotton Fibers and Methods of Manufacture” filed Nov. 4, 2013, both of which are entirely incorporated by reference.

### BACKGROUND

1. Field of the Invention

The present invention is directed to ignition resistant and/or flame retardant bi-regional cotton fibers, and bi-regional cotton fibers having a bleached and/or dyed cellulose region at the core and an outer region comprised a wax sheath or surface. In particular, the invention is also directed to methods for the manufacture of the ignition resistant bi-regional cotton fiber, and to articles made from a multiplicity of said bi-regional cotton fibers.

2. Description of the Background

Cotton is a natural fiber and is renewable. That is, a new crop can be grown each year. Most synthetic fibers are made from petroleum which is not a renewable resource. Cotton has been known for thousands of years, and accordingly, the physical and chemical properties about cotton are well known. Because of a unique chemical nature, cotton can be made to be fire retardant, have wash-wear qualities, and be wrinkle free, among other properties. Cotton also can be blended with other textile fibers to enhance the overall performance of the blended fabric.

According to Cotton Inc., the US produced 15.5 million bales of short staple cotton and 583,000 bales of long staple cotton in 2014. Each bale weighs 480 pounds. This represents only a small fraction of the world cotton production. This converts to 5.56 million metric tons of short staple cotton and 140,000 metric tons of long staple cotton produced in the USA. The State of Texas is the largest producer accounting for 40 percent of this crop followed by Georgia, Mississippi, North Carolina, Arkansas and Alabama.

Raw cotton, in other words the unprocessed material obtained from plants, like all vegetable matter contains minerals, resins, gums, protein, tannins, oils and waxes and carbohydrates in addition to cellulose. Cotton normally has to be purified to remove these products from the primary cellulose polymer substrate. Natural cotton is typically bleached in either the yarn form or the fabric form. This involves boiling the cotton for 30 plus minutes in a strong alkaline solution. This process cleanses the cellulosic part of the cotton and removes the natural wax on the outside of the cotton.

Most of the unwanted portions of the cotton plant material are removed in a “Kier” boil process. This has become the standard treatment process in which caustic soda (NaOH) and other processing aids are employed at temperatures of up to 100° C. to solubilize and remove impurities. The oils and waxes are saponifiable and removed by this preparation process. Continuous processes have been developed which utilize a steam treatment (100° C.) to speed up the process and reduce the time required by the Kier (batch) method. A comparison of the composition of raw cotton versus a Kier like treatment is shown in Table 1.

TABLE 1
Percent Composition of Cotton: Raw vs. a Kier* Treatment

| | Raw Cotton | KIER |
|---|---|---|
| Cellulose | 80-85 | 99.1-99.5 |
| Wax | 0.4-1.0 | 0.01-0.15 |
| Ash | 0.8-1.8 | 0.05-0.075 |
| Pectin's | 0.4-1.1 | Nil |
| Protein (Nitrogen) | 1.2-2.5 | 0.05-0.10 |
| Pigment, Resin | 3-5 | Nil |
| Moisture | 6-8 | Nil |

*(Mathews' Textile Fibers, 5^{th} ed. Wiley & Sons, NY, 1947 p, 100)

Virtually all impurities are removed by Kier boil treatment. Color is removed by a subsequent bleaching process normally employing either peroxide or hypochlorite process which removes the color to the desired degree of whiteness. Following these treatments, the cotton fabric is ready for numerous after-treatment processes such as dyeing by any of a variety of methods, conversion to a wash-wear, conversion to flame and/or ignition resistance and/or other treatments, including combinations of all of the above. Further treatments to enhance the utility of treated cotton fabric or cotton fabric blends are known.

The wax in the cotton fiber is not one having a single component, but is thought to have a blend of complex esters, acids and alcohols. The waxes are thought to have a composition involving C24-C34 primary alcohols as well as other complex mixtures and a melting point of about 77° C., a density of 0.976, an acid value of 29, saponification value of 57 (after acetylation, 137), an acetyl value of 84, an iodine number of 27, and 68% of un-saponifiable material (having an acetyl value of 123—indicating an absence of wax esters and a large proportion of free wax alcohols). It is probably the free wax alcohols that survive the treatment conditions outlined in the Kier and like processes. The purpose of the wax in the fiber is to protect the cotton seed from the harsh environments it may be subjected to prior to spring planting. Loose raw cotton will float on water for months; hence the cotton seed is protected against winter rains damage. Still, it is these wax components that survive the processing treatments which results in the surprise benefits of ignition resistance cotton.

PCMs (phase change materials) are widely used for textile applications. Mainly in bedding, PCMs are used to obtain a cooler comfort or sleep. Other applications vary from apparel, bedlinen, coatings, etc. However, the main incentive to use PCMs is the marketing. Other cooling technologies are either based on synthetic hydrophilic fibers or the use of hydrophilic finishes which purely works on the traditional principle of moisture management (for example, instant waterdrop of 0 seconds).

Traditional PCMs show similar restrictions or applications. For example, in textiles, PCMs based on synthetic waxes typically use octadecane (220 J/g), heptane, or other substances. The typical melting points of PCMs varying from 10° C. up to 35° C. (not restricted). Octadecane will show its peak melting at 28° C. These waxes usually have a density of about 0.6. In reality, the wax will only show cooling sensation to the body as the skin temperature typically varies between 28-35° C. As such, the mode of action is limited in time. Active waxes are encapsulated in, for example, melamine formaldehyde capsules, acrylic, urethane, or another kind of encapsulation polymer. The ratio between wax/capsules might vary from 50/50 to 90/10 or more. In reality, the encapsulation will reduce the amount of wax or capacity to absorb heat. Some companies apply waxes without encapsulation, however, due to the wax's melting point at or near room temperature, those fabrics will often show a greasy and dirty appearance. Besides the encapsulation itself, the capsules need to be fixed to the textile, for example, by using either binders, either self-crosslinking or reactive technologies. Problems occur due to the chemistry (cost, waste, etc.) sustainable impact, impact on softness and appearance of the treated textile, limitations in applications, limited durability to washing and processing parameters.

To reduce the inherent flammability of cotton fabrics, cotton fiber can be combined with flame and/or ignition resistant fibers, such as synthetic fibers. For apparel use modacrylic fibers and matrix fibers of vinyl/vinyon, among others, have been used.

The resulting fabrics frequently lack the performance properties and consumer appeal of pure cotton fabric. Fiber composed of 50 percent vinyl and 50 percent vinyon, for example, is not strong enough to form its own fabric and is not easily dyed. Another disadvantage of this method of producing fire resistant fabric is that yarns containing two or more fibers with different flammability characteristics which tends to produce fabrics having non-uniform cross-sectional areas, and therefore, non-uniform fire-resistant characteristics.

Alternatively, cotton fabric can be treated with flame retardant chemicals and/or chemicals that promote ignition resistance that change or interrupt the burning process known as pyrolysis. However, cotton fabric treated with such chemicals lack the performance properties and consumer appeal of pure cotton fabric. Most of these treatments involve harsh chemicals which are very unfriendly to the environment or use chemicals that are not durable and wash out after several uses. The fabrics typically have an unpleasant odor even after multiple washes. Several have also been linked to health problems in infants and newborns. For this reason, most of the newborn and infant bedding and sleepwear has been switched to 100 percent polyester. U.S. Pat. No. 9,074,316 describes a process of treating textiles with a phosphorous compound to achieve fire resistance. As shown in table 2 of the patent, cotton must be blended with polyester and then treated according to the invention to pass a flammability test after 50 washings. Furthermore, applying the flame retardant chemicals is a complex and costly process. The processes typically require multiple padding, bleaching, curing, oxidation and washing steps to ensure the flame retardant is wash permanent.

During pyrolysis most textile materials must first undergo decomposition to form volatile combustibles before they will burn. Decomposition occurs when the textile material is exposed to a sufficient source of heat. The decomposition temperature for textile materials is dependent upon the composition of the material and is different for different fibers. When the textile material decomposes, volatile materials are formed. The volatile materials ignite in the presence of oxygen to produce heat. The heat produced during pyrolysis may cause further decomposition of the textile material leading to its complete destruction.

The application of flame retardant chemicals or chemicals that provide ignition resistance interrupt pyrolysis. For example, the flame retardant or ignition resistance may be converted upon heating into acids and bases that catalyze decomposition of the textile at lower temperatures than are required for the formation of volatile combustibles. Compounds containing phosphorus are converted to acidic materials that catalyze the thermal decomposition of the polymer. Alternatively, the flame retardant or ignition resistance chemicals may decompose or sublime upon heating to release large amounts of nonflammable vapors which exclude oxygen from the flame.

A need exists for a cotton fiber that is inherently flame and/or ignition resistant such that fabric made from these fiber complies with flammability and safety regulations without application of harsh chemicals, or with application of reduced amounts of chemical compared to fabric made from untreated cotton fibers. Furthermore, there is a need for all cotton fabric that is adapted to pass flammability tests after 50 or more washings.

A need also exists for a cotton fiber that is made inherently flame and/or ignition resistance such that fabric made from these fibers complies with flammability safety regulations by having an ignition resistant wax sheath without application of flame retardant chemicals, or with application of reduced amounts of such chemical compared to fabric made from untreated cotton fiber.

### SUMMARY OF THE INVENTION

The present invention comprises a major departure from the present state of the art by discovering that bi-regional cotton fiber which has a wax sheath and is optionally impregnated with a phosphorous compound unexpectedly has flame retardant and/or ignition resistant properties, even after being dyed under low temperature and alkaline conditions and washed multiple times.

One embodiment of the invention is directed to a flame retardant fiber. The fiber comprises a cotton fiber cellulosic center impregnated with phosphonium salt, an outer surface comprised of natural cotton wax from the cotton fiber, and wherein the average char length of the flame retardant fiber is less than 0.5 inches.

Preferably, the fiber is bleached. In a preferred embodiment, the fiber is bleached with chlorine, ozone, peroxide, hypochlorite or a combination thereof. Preferably, the wax comprises at least 0.4 percent by weight of said fiber. Preferably, the wax comprises from about 0.4 percent to about 25 percent by weight of said fiber. Preferably, the wax comprises about 14 percent to about 16 percent by weight of said fiber. In a preferred embodiment, the fiber has at least 10 or at least 20 percent greater tensile strength and/or abrasion resistance as compared to natural cotton fibers.

In a preferred embodiment, the fiber preferably comprises a saponified acid or derivative thereof applied to the outer surface of the fiber. Preferably, the saponified acid or derivative thereof comprises lauric acid, myristic acid, palmitic acid, stearic acid, oleic acid or combinations thereof. Preferably, the char length is determined according to at least one of FAR 25.853(b) or 16 CFR Parts 1615 and 1616. In a preferred embodiment, the char length is maintained after 50 washes and/or after 100 washes. Preferably, the fiber has reduced water absorption as compared to a natural cotton fiber.

Another embodiment of the invention is directed to a textile comprised of a plurality of the bi-regional fibers comprised of a cotton fiber cellulosic center impregnated with phosphonium salt, an outer surface comprised of natural cotton wax from the cotton fiber, and wherein the average char length of the flame retardant fiber is less than 0.5 inches. Preferably, the textile is fire retardant and/or ignition resistant. The char length is preferably maintained after 50 washes and/or after 100 washes. Preferably, the textile has reduced water absorption as compared to a natural cotton fiber.

In a preferred embodiment, the textile has a wrinkle resistance greater than conventional cotton. In a preferred embodiment, the textile is comprised of additional fibers. The additional fibers preferably comprise natural fibers, synthetic fibers, carbonaceous fibers, and combinations thereof. Preferably, the synthetic fibers comprise polyester. Preferably, the synthetic fibers comprise about 50 to about 90 percent polyester and about 10 to about 50 percent bi-regional fibers. Preferably, the carbonaceous fibers are flexible bi-regional carbonaceous fibers.

Preferably, the textile is formed into apparel for infants, toddlers, children or adults. The apparel preferably comprises shirts, socks, pants, sweaters, sweats, gators, hats, scarves, coats, undergarments, sportswear, skirts, dresses, tops, blankets, and designs and combinations thereof. Preferably, the apparel is suitable for wear in environments where conditions are greater than and/or less than body temperature.

Other embodiments and advantages of the invention are set forth in part in the description, which follows, and in part, may be obvious from this description, or may be learned from the practice of the invention.

### DESCRIPTION OF THE DRAWINGS

The invention is described in greater detail by way of example only and with reference to the attached drawings, in which:

FIG. 1 is an embodiment of an impregnated bi-regional cotton fiber.

FIG. 2 depicts an embodiment of a method of fireproofing and dying a fabric.

FIG. 3 depicts an embodiment of the heat absorptive properties of cotton wax.

### DESCRIPTION OF THE INVENTION

Cotton fabric can be made flame retardant or ignition resistant by treating with certain chemicals that change or interrupt pyrolysis (e.g., organohalogens, compounds containing bromine or chlorine). These treatments typically involve harsh chemicals which are unfriendly to the environment and linked to health problems. Many of these compounds are known to be harmful and may be carcinogenic and/or toxic. In addition, cotton fabrics so treated lack the performance properties and consumer appeal of pure cotton.

It has been surprisingly discovered that cotton fibers can be made fire retardant and/or ignition resistant without the need for harsh or harmful chemical treatments by creating the bi-regional fibers of the invention and optionally treating the fibers with phosphoric salts. The bi-regional cotton fibers of the invention are made from regular, ecru (i.e., raw) or unbleached cotton either in the yarn or in fabric form. The resultant bi-regional cotton preferably has at least about a ten percent or greater tensile strength and/or abrasion resistance as compared to untreated or conventionally treated cotton fibers, more preferable about 20 percent or greater, more preferably about 30 percent or greater, more preferably about 50 percent or greater. Preferably, the bi-regional cotton has three times the burst strength of traditional cotton and is able to withstand over 25,000 rubs in the Martindale abrasion test with no fabric wear. Regular cotton fails after 2,500 to 3,000 rubs in this test.

Fibers of the invention with increased tensile strength and/or abrasion resistance as compared to regular processed cotton using high temperature and high alkalinity, also have surprisingly superior moisture handling capabilities and wrinkle resistance as compared to traditional cotton. Superior moisture handling capability means that the fiber or fiber assembly is less absorbent of water.

The bi-regional cotton fibers of the invention are preferably ignition resistant and flame retardant and pass the 45-degree angle flame impingement test as prescribed for children sleepwear in the United States after 50 washes, after 75 washes, after 100 washes, and after additional washes. The bi-regional cotton has no harsh chemicals in contact with the infant's skin. The chemical treatments conventionally required for flame and ignition resistance normally used in traditional cotton have been linked to sudden infant death syndrome and low IQs. Further, the cost of making the bi-regional cotton is competitive with polyester and should restore cotton as the material of choice for newborn, infant and children's clothing.

The preferred embodiment of bi-regional cotton retains the natural cotton waxes and cotton oils of the raw cotton and requires no additional finishes or lubricants and has superior handling compared with traditional cotton fabrics. The bi-regional cotton dyes in a more uniform manner than traditionally processed cotton, such as by the Kier process, and has far superior comfort properties.

The intended consequence of the Kier process, which is the standard processing of cotton, is that it removes all of the wax from the cotton fibers. A low alkaline and low temperature process has been developed that does not remove the natural cotton waxes. It was surprisingly discovered that an unexpected result of such a treatment allows the wax to either migrate to the surface of the cotton fiber or does not remove the surface wax thereby markedly increasing the ignition resistance of the final cotton fabric. The ignition resistance of the bi-regional cotton can be further improved by saturating the fibrous core with phosphorous salts. Also, the method with mild heating migrates the wax to the surface forming the bi-regional fiber. Other properties such as an enhanced hand feel and smoothness of the fiber assemblies, is also obtained. The process requires that all treatments must be performed at a low temperature and alkalinity so as not to result in unintended saponification which could solubilize and result in removal of the wax. Preferably, the low temperature is lower than the melting point of cotton wax.

Dye-ability is an important asset for any textile fiber. Cotton is fortunate that it can be colored by numerous different dyeing classes. Unfortunately, many of these such as vat, sulfur and/or naphthol, are performed employing high alkaline conditions. The choice of dye class varies in the fastness properties they are able to impart to the finished dyed cotton such as light fastness, wash fastness, fastness to perspiration and the like. To achieve uniformity of dyeing, the cotton is first prepared so that a uniform uptake and leveling of the applied dyestuff is achieved. The traditional preparation step involves a Kier type treatment followed by bleaching to remove natural colored impurities. The most desirable dyeing conditions which insure survivability of the residual wax is a low temperature/low alkali reactive dyeing process.

Accordingly, the traditionally employed Kier/bleach process can be replaced with either a low temperature—peroxide/catalyst or low alkalinity hypochlorite process. These bleaching steps employ an oxidative rather than a high heat/alkalinity process to remove cotton impurities. The result is a process that retains essentially all of the natural waxy composition of the cotton fiber. In addition, the wax appears un-expectantly to either migrate to the surface of the fiber or remain on the surface and is not removed by these oxidative processes. This process creates a natural cotton wax layer on the outer surface of the cotton, thereby causing fibers to be bi-regional. This surface wax contributes to improving the ignition resistance of the fabric.

When using peroxide bleaching, the bleach temperature preferably does not exceed 60° C. Traditional peroxide processes are done at the boil or employ a steaming step, for example, by saturated steam at 100° C. or greater for continuous operations. Instead of employing a high alkalinity to stabilize the peroxide bath, only a 2 g/1 caustic solution is employed along with a complex blend of low foaming surfactants, a stabilizer, and a catalyst that is active at the lower temperature is employed. Any remaining peroxide is preferably neutralized employing a non-alkaline agent.

If chlorine bleach is used, preferably 1 g/l Cl₂ is employed in the bleach bath to prevent over bleaching and pH is maintained at 7.5 to 8.0. Preferably sodium carbonate is used as buffering the bleach bath instead of caustic soda. This reduces the potential saponification of the wax. At lower pH, the bleaching action increases. For cotton fabrics with high natural color content, the temperature can also be increased, but should preferably not exceed 40° C. Preferably the temperature is 40° C. or below, more preferably 30° C. or below, more preferably 25° C. or below, and more preferably at about ambient or room temperature. In such cases it is preferred to employ the weaker (1 g/l Cl₂) bleach solution at a higher temperature than to use stronger bleach solutions at lower temperatures. This is because the activity of the OCl⁻ ion responsible for the bleaching is temperature dependent (see, R. H. Peters, Textile Chemistry Vol. II, Elsevier, New York 1967). Traditional chlorine bleaching processes, pads the bleach solution onto wet goods such as fabric directly from the kier process. In the process of the invention, the bleach is applied directly to the dry cloth and problems associated with bleaching uniformity in the fabric are reduced. The bleach solution can be applied by any of the application processes such as, for example, spraying, foaming, padding or the like.

Acidic products are produced as the oxidation process proceeds which reduce the normal alkalinity present. Ordinary bleaching with chlorine requires additional alkali to insure neutralization of the HCl which is formed during bleaching. This results in excessive alkali being present after bleaching which is removed usually by a post treatment with acetic acid. Another advantage of this bi-regional cotton process is that an acetic acid wash step, to remove residual alkali, can usually be omitted since very little residual base should be present after the bleaching process. This saves processing time and also expense. The pH of the fabric will be sufficiently low after rinsing so as not to interfere with subsequent dyeing processes.

In a continuous process, J boxes can be employed to store the padded cloth but the dwell time preferably does not exceed 20 minutes. As with any chlorine bleach methods any residual chlorine is preferably neutralized with either sodium thiosulfate or sodium bisulfite antichlor.

Bleaching with bromine is faster than with chlorine but generally the method is not as cost effective as with chlorine. Small amounts (e.g., 1-2 percent of bromine on weight of chlorine content) added to the chlorine bleach solutions also measurably improves bleaching efficiency (see, R. H. Peters, Textile Chemistry, Vol II, Elsevier, New York, 1967).

Other cellulosic fibers that do not have a natural wax content similar to bi-regional cotton of the invention are preferably treated with a topical wax and receive the same or similar ignition resistance. These other cellulosic fibers include the Rayon, Linen, although non-prepared Linen has a natural wax content of 0.5-2.0 percent (having a melting point of about 62° C.) as well as blends. In these cases, it is possible to subsequently treat the cellulose containing fabrics with a number of natural wax emulsions. The temperatures of drying will allow the emulsified wax to evenly distribute itself and become affixed on the fiber surface to achieve the bi-regional structure and the same ignition resistance as the so treated cotton.

This technique can also be employed to treat cotton fabrics processed in the classical fashion such as, for example, by the Kier process which removes virtually all natural wax. A number of high melting petroleum based waxes are also known and are available that will also have utility as substitutes for the natural waxes. Preferred waxes include, but are not limited to carnauba, bees wax, palm, soy, candelilla, jojoba, wool waxes, and the like and combinations thereof (see Table 2). Blends of natural waxes and petroleum based waxes may also be utilized. Cotton having different processing histories can be treated with these types of wax blends and are included within the scope of the invention.

TABLE 2
Melting Points of Some Natural Waxes (° C.)

| | |
|---|---|
| Bees Wax | 62-65 |
| Palm | 58-60 |
| Carnauba | 81-86 |
| Candelilla | 68-73 |
| Soy (high melting type) | ~82 |
| Jojoba (high melting type) | ~70 |
| Cotton | ~77 |

In addition, blends of cellulosic fibers will benefit from a post application of an emulsified wax or combination of waxes. The application of the saponified acid derivatives such as, for example, lauric, myristic, palmitic, stearic, oleic and combinations thereof provide ignition resistance to treated fabrics. These products are removable in a conventional laundry cycle, but are preferably useful for fabrics that are not intended to be laundered.

Once the fabric has been bleached it is preferably dyed. The dyeing method of choice is with reactive dyes that can be dyed at temperatures not exceeding 60° C. and at low alkalinity. The dyes form a covalent dye with active hydrogen on the cotton fiber. The dye is preferably salted on with high concentrations of sodium chloride. The amount employed depends upon the dye level required to produce the required shade. Table 3 provides levels of salt to employ and concentration of alkali. A preferred alkali is soda ash and can be employed to achieve the fixation of the dye. Once the dye reaches the desired equilibrium, for example the proper shade, 2 gpl soda ash is added to fix the dye within the fibers. This level of alkalinity does not result in saponification of the surface wax. Dyeing is continued at the 60° C. until fixation is assured.

TABLE 3
Salt and Alkali Concentrations at Specific Dye Add-ons

| Percent Dye on Fabric | NaCl (gpl) | Soda Ash (gpl) |
|---|---|---|
| <0.50 | 20 | 10 |
| 0.50-1.0 | 35 | 15 |
| 1.0-2.0 | 50 | 20 |
| 2.0-4.0 | 60 | 20 |
| >4.0 | 80 | 20 |

One disadvantage of cotton fabric is that the material ignites easily and burns rapidly. The flammability of a fabric is dependent upon its composition (see, Mehta, R. D., Textile Research Journal 44(10): 825-826 (1974)). The extent of flame and glow resistance of a fabric increases as the carboxyl and metal contents of the fabric increased. In view of the danger posed by flammable textiles in general, the government has promulgated consumer safety regulations for textiles including safety standards for carpets and rugs, mattresses and children's sleepwear. The flammability characteristics of textiles used to manufacture upholstery found in motor vehicles and airplanes are also regulated.

In one embodiment, the invention comprises a bi-regional cotton fiber, fiber assembly or fabric. The cotton or cellulose (e.g., cellulosic) core fiber comprises the fiber core at least 70 percent of the fiber by weight and has a wax sheath or coating (also referred to as the outer core) comprising at least 2/10 of a percent to 25 percent of the bi-regional cotton fiber by weight. The wax coating may be high temperature (high melting point) wax which is preferably a melting point at or above 70° C. Alternatively, the wax coating may be of lower temperature melting wax. This bi-regional fiber contains a unique blend of cellulose with wax. The wax may be a naturally occurring wax from the processed cotton itself or it may be an emulsified wax added to the fiber surface. This wax can be added to the fibers after a low temperature processing, preferably less than 70° C. In another embodiment, the wax may be coated on the fibers after standard process such as, for example, Kier processing.

In one embodiment, the wax may constitute about 0.4 to 1 percent by weight of the cotton fiber. In another embodiment, the wax may constitute about 10 to 25 percent by weight of the cotton fiber. In another embodiment, the wax may comprise about 14 to 16 percent of the cotton fiber by weight.

The fibers or woven fabric made from such fibers become an ignition resistant fiber. This is attributed to the high wax content of the fibers coating the exterior (see Example 4). The fibers or fabric preferably exhibit a smooth, silky texture and enhanced moisture (water wetting) resistance as a result of the wax coating. Fiber of the invention is preferably stronger than standard cotton fibers because of the milder processing conditions employed, such as, for example, lower processing temperature. The cotton of the invention preferably possesses flame resistance (flame retardant and/or ignition resistance) to meet flammability safety regulation without application chemical additives or with application of reduced amounts of flame resistant chemicals. For example, the wax coating of the fibers prevents the fibers from combusting prior to the wax melting away. This allows the fibers to be present in a fire without combusting for longer periods of time that traditional, unwaxed cottons. The longer time to combustion provides for greater compliance, for example, 16 CFR §§1615 and 1616.

In an effort to increase the flame resistance of the bi-regional fabric, the fabric is preferably treated with a flame suppressant, for example a phosphorous compound or a carbon compound. The phosphorous compound can be, for example, phosphates, phosphines, phosphinates, and phosphonium salts. The phosphonium salts are preferably tetrakis(hydroxymethyl) phosphonium salts. For example, THPS (THP sulphate), THPC (THP chloride), THPP (THP phosphate), THPS-Urea, THPC-Urea, etc. Preferably the treatment involves applying a the flame suppressant to the bi-regional fabric such that the fibrous core becomes impregnated with the flame suppressant. The flame suppressant increases the minimum oxygen concentration necessary to support combustion of the fabric from 20-21 to above 28 Limited Oxygen Performance (LOI). For example, with phosphonium salts, as the flame begins to heat the phosphonium salts within the fibers, phosphorus is emitted, decreasing the available oxygen and, thereby, reducing the ability of the fibers to combust.

The United States Consumer Product Safety Commission has enforced flammability requirements for children's sleepwear since at least 2001. These requirements are intended to protect children from burns. They require sleepwear between sizes 9 months and 14 to be flame resistant and able to self-extinguish if caused to catch fire.

Children's sleepwear, for purposes of the regulations, includes any article of clothing intended to be worn primarily for sleeping or activities related to sleeping, such as nightgowns, robes, pajamas, and loungewear. Most garments sized 9 months or under do not have to meet these requirements, but they do have to meet the general flammability requirements for clothing textiles.

To comply with the regulations, manufactures are required to test the fabrics being used to manufacture children's sleepwear. Manufacturers are required to test the fabric, seams, and trim both as the garments are produced and after being laundered fifty times. The test consists of applying a gas flame for 3 seconds to a vertically held 3.5 inch by 10 inch specimen of the fabric or seam. The char length on the fabric is then measured to determine compliance. See UNITED STATES CONSUMER PRODUCT SAFETY COMMISSION. LABORATORY TEST MANUAL FOR 16 CFR §§1615 and 1616:

Standards for the Flammability of Children's Sleepwear. In order to meet the requirements of the Standards, children's sleepwear must meet the following criteria stated below and in §1615.3(b) and §1616.3(b):

1) The average char length of the sample does not exceed 17.8 cm (7.0 in) and

2) No individual specimen has a char length of 25.4 cm (10.0 in).

The resultant fabric preferably remains water repellant after 50 washings and passes vertical burn tests with 0 sec after flame and 0 dripping. Preferably, the wax outer surface keeps the phosphonium salts from washing out. The fabric may be used as a low cost soft fire-blocking material for latex mattresses.

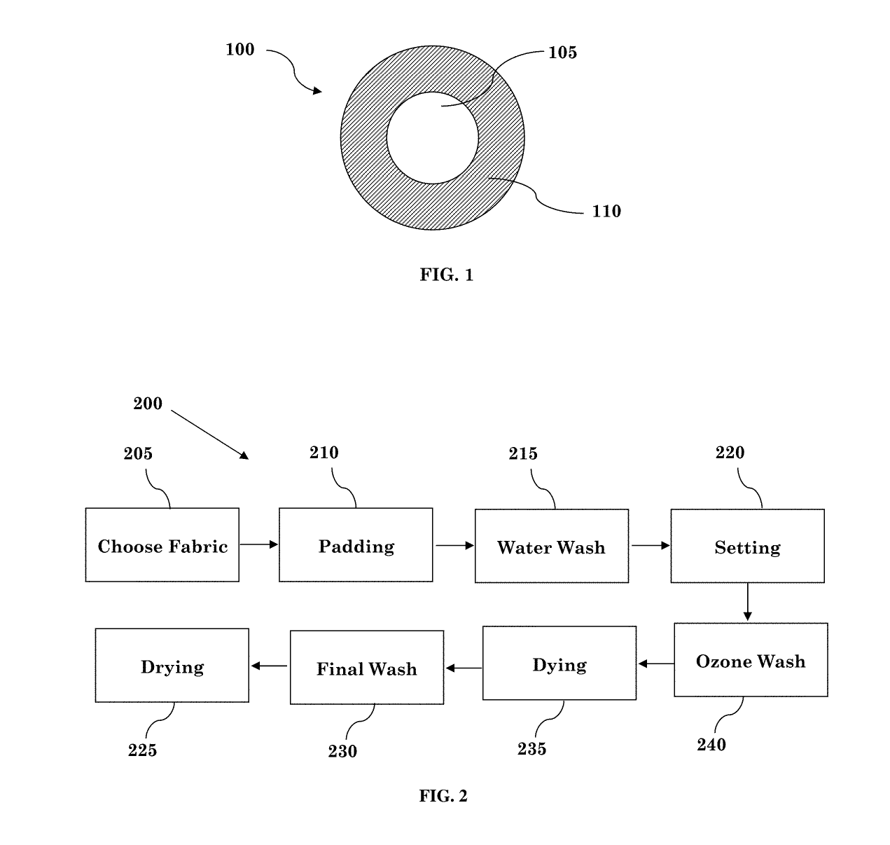

Excess salts may be removed by oxidizing the textile with ozone. Additionally, the textile may be set by subjecting the fabric or fibers to heat in excess of 200° C. FIG. 1 depicts an embodiment of the treated fire resistant bi-regional fiber 100. Preferably, the inner region 105 is a cellulous fiber impregnated with a phosphorus compound and the outer region 110 is a wax coating. Preferably, the arrangement shown in FIG. 1 allows the textile to remain fire resistance after 50 washes, after 75 washes, after 100 washes, or after additional washes. Additionally, the wax coating preferably protects the cellulous fibers from eroding during washing and there is no or limited weight change in the textile after washing.

The natural wax has the capacity to absorb heat and finally will melt at 80° C. By absorbing the heat of the flame, the wax reduces the heat of the flame during the ignition phase. The hydrophilic core of the bi-regional cotton, contains 5-10% of moisture, which is trapped inside by the melting wax. The energy needed to evaporate the moisture will enhance an endothermic reaction or cool down the flame during the ignition of the fabric.

Furthermore, the natural wax acts as a phase change material (PCM). The wax has an enthalpy near 140 J/g, which is in line with commercial synthetic PCMs (100-250 J/g, which will be lower after encapsulation). Cotton wax starts to absorb heat above 30° C.

As can be seen in FIG. 3, as the cotton wax starts to absorb heat, the wax transitions through several solid structures before melting. On the other hand, synthetic or biobased PCMs start to melt, for example, at around 28° C. The synthetic or biobased PCMs, are typically completely molten at 35° C. In use, the synthetic or biobased PCM will melt completely in a few seconds/minutes after contact with the body's skin temperature. Most synthetic or biobased PCMs start to melt at room temperature and are already saturated before skin contact.

Furthermore, traditional PCMs shows limited durability to washing, either due their size or binding system to the fibers. The natural cotton wax, which preferably coats every single fiber, has enhanced wash durability if proper laundry specifications are taken into account (for example, below 80° C., not high alkaline, and specific enzymes or chemicals avoided). Preferably, the cotton wax only melts near 75° C., outside the range of body temperatures. Therefore, the cotton wax can absorb heat for a very long time. For example, the cotton wax can absorb heat from skin temperature that is constant in the range of 28-35° C. Additionally, the cotton wax can absorb heat from sunshine, which can elevate the temperature of the cotton wax above 40° C., and still have the capacity to continue to absorb heat from sun.

In other embodiments, the cotton waxes can be extracted and re-apply on other fibers based on their 100% natural and sustainable profile to provide similar cooling sensations. Synthetic or biobased PCMs have a very low density, and a high-volume change during melting or solidification. As such, they show a poor thermal conductivity. The cotton wax, in conjunction with the hydrophilic core, has increased thermal conductivity over synthetic or biobased PCMs. The bi-regional cotton described herein provides the cooling sensation combined with natural fibers and ignition resistant performance. On the other hand, commercial synthetic or biobased PCMs are typically a fuel load on fabrics which negatively impacts the flame retardant protection. Therefore, heavy loading of FR chemicals is required to compensate the negative impact of traditional PCMs on flame retardant protections. The heavy loading of synthetic or biobased PCMs (as a consequence of their very short time of cooling action) and heavy loadings of FR chemistry dramatically impacts the comfort and aesthetics of the textiles.

The bi-regional cotton described herein preferably provides a first line of cooling effect and comfort. As body vapor will diffuse through the yarn and fabric structure, generating an accelerated drying and cooling effect from the inside-out. This also means a nice dry touch from the bi-regional cotton to the skin. During exercises, sports, or other exertions, increased level of sweating will cool down the body skin temperature. A second line of cooling effect, is preferably experienced as the natural cotton wax begins to absorb sun heat as of 35° C. and shows continuous capacity to absorb heat (for example running a race when it is hot outside), or, shows a very long mode of action by absorbing body heat (of about 33-35° C.) for long periods of time synthetic or biobased PCMs.

As every single fiber is preferably covered by the natural cotton wax, the fabric maintains the air and vapor permeability and unmatched wash durable performance. Most commercial PCMs are bigger in size than the individual fibers, and will literally close the fabric pores, thereby reducing breathability, which will negatively impact the comfort of the wearer despite their initial cooling performance.

The natural cotton wax will preferably neither fully melt (maintain dry touch) nor fully solidify (maintains softness) under normal wear conditions, but instead will preferably remain in an intermediate phase. As such, the cotton wax will preferably instantly respond to higher temperatures (by absorbing heat for an extended period of time, thereby keeping the wearer cooler) and to lower temperatures (by releasing the stored heat from the intermediate “thermoplastic” phase and convert stored radiant/convective heat into convective heat to the surroundings, thereby keeping the wearer warmer).

It has also been surprisingly discovered that blends of the cotton fiber of the invention can be made with flexible bi-regional carbonaceous fibers (BRCF) as described in U.S. Pat. No 5,700,573. Blends comprising preferably from 10 to 90 percent of the cotton fibers of the invention with the balance of the fibers being BRCF. Preferably untreated cellulose core fiber comprises at least 70 percent of the fiber by weight and the wax sheath comprises from at least 0.2 percent to 15 percent of the cotton fiber by weight. These blends are made into knitted fabrics having densities ranging preferably from 3 to 15 ounces per square yard are ignition resistant and have superior cooling properties due to the micro evaporative cooling nature of both the cotton fibers of the invention and the BRCF The ignition resistance of the fabric blends, utilizing the BRCF and/or the cotton fibers of the invention, are determined following the test procedure set forth in 14 C.F.R. §25.853(b). Samples preferably pass an FR test and exhibit superior thermal resistance values with clo thermal resistance values ranging from 2.6 to 3.6.

The low-energy room temperature method of cleaning and bleaching leaves the natural wax sheath around the cotton resulting in significant energy savings and carbon dioxide emission reductions, in comparison to the traditional high pH effluent process. For each metric ton of cotton, the process of the invention produces cotton which reduces CO₂ emissions by 560 pounds and reduces energy consumption by 906 kWh. When this process is widely adopted in the USA, CO₂ emissions can be reduced by up 4.43 MM tons and up to 14 GWh. Besides the significant positive environmental impact, the superior cotton is up to 30 percent stronger, shows inherent reduced ignitability, enhanced moisture wicking, stain and easy care properties. Clothing and articles made from the smarter cotton are environmentally green and made from a sustainable material compared to synthetic materials. For example, 5.7 million metric tons of cotton will save 906 kWh (kilowatt hours) and 506 lbs. per metric ton. Two forms of smarter cotton are released to the market.

One form of the cotton of the invention that comprises premium long staple combed cotton is referred to herein as NuGard. NuGard is a form of cotton fibers of the invention that has significantly improved properties compared to conventional forms of cotton. NuGard maximizes the wearer's comfort in addition to reduced ignitability without adding flame resistant chemicals. Articles composed of NuGard are extremely cool in warm weather, have a naturally ultimate soft silky hand, and show reduced tendency to staining and wrinkling as compared with conventionally treated cotton and polyester. Sweat rings with Nugard are not present thanks to its micro-evaporation power. The natural wax repels instant spills, facilitates vapor transport inside-out keeping the wearer cool and dry to the skin. Instead of compromising performances, the sustainable lower energy process is in synergy with enhanced comfort, quick dry laundry and easy care conditions. Bi-regional cotton fibers of the invention including Nugard cotton can be made into most any apparel including apparel for infants, toddlers, children and adults such as, for example, shirts, socks, pants, sweaters, hats, scarves, gators, sweats, coats, undergarments, sportswear, skirts, dresses, tops, and blankets. Other embodiments of the invention comprise materials composed of fibers of the invention combined with additional fibers and other materials, such as, for example, leathers, metals, plastics and other polymers in creating most any design and style of clothing and apparel. Workhorse cotton fabric products such as underwear, denim jeans, sheeting, bedding, children's clothing, and the like can be referred to as DuraGard products.

Treated cotton, because of the wax coated surfaces has the following preferred characteristics: (i) increased staining resistance and improved soil release characteristics; (ii) natural softness and hand; (iii) natural water repellency providing greater dry sleeping comfort; (iv) when blended with diamondown will provide superior thermal comfort by blocking 91 percent of radiant heat loss; (v) enhanced fabric wick ability; (vi) less problems associated with dyeing; and (vii) acts as a PCM. Fabrics manufactured employing the so treated cotton will experience a greater degree of polymerization (DP) in the final fabric because of the less harsh preparation and process treatments normally employed. As a consequence, in a comparison of water-repelling cotton of one embodiment of the invention shows water beading on and not within the fabric, whereas traditional cotton shows water being absorbed by the fabric. Also because of the lower processing damage, the fabrics possess increased tenacity (about 14 percent) and elongations (about 14 percent). In addition, the milder processing reduces the associated energy costs (about 20 percent minimum) as well as lower water consumption and waste water treatment requirements. There is also a lowering of the CO2 emissions (about 17 percent minimum) because the processes are preferably accomplished at lower temperatures.

Forms of the invention herein shown and described are to be taken as the presently preferred embodiments. Various changes may be made in the shape, size and arrangement of components or adjustments made in the steps of the method without departing from the scope of this invention. For example, equivalent elements may be substituted for those illustrated and described herein and certain features of the invention maybe utilized independently of the use of other features, all as would be apparent to one skilled in the art after having the benefit of this description of the invention.

The term “ignition resistant” as used herein refers to fibers or fiber assemblies that satisfactorily pass the (a) FAR 25.853(b) Flammability of Aircraft Seat Cushions, or (b) flammability test or the 45 degree angle flame impingement test (16 CFR 1610, Standard for the Flammability of Clothing Textiles).

The term “fiber assembly” used herein applies to a multiplicity of fibers that are in the form of a yarn, a wool like fluff, batt, mat, web or felt, and comprising a formed sheet, screen or panel, a braided, knitted or woven cloth or fabric, or the like.

The term “cohesion” or “cohesiveness” used herein, applies to the force which holds fibers together, especially during yarn manufacture and is a function of the type and amount of lubricant used, the fiber crimp and twist.

The term “Kier process” as used herein refers to the prior art standard processing of treating raw cotton by boiling the cotton to remove oils and waxes by saponification from the primary cellulose polymer substrate.

The term “high temperature high alkalinity processed cotton” means cotton processed by the Kier process or similar processes conducted at temperatures of near 100° C.

All percentages disclosed herein are “percent by weight” unless otherwise specified.

The following examples illustrate embodiments of the invention, but should not be viewed as limiting the scope of the invention.

### EXAMPLE 1

Bleaching with Peroxide

To the cotton fabric is added a solution containing 3-4 gpl, peroxide (50%), 2 gpl caustic soda (NaOH), and 1 gpl of a low foaming surfactant/stabilizer at a 10/1 fabric to liquor ratio. The fabric and solution is heated to 60° C. over 15 minutes. One gpl of a catalyst suitable for low temperature peroxide bleaching is added and the fabric heated in this mixture at the 60° C. temperature for 45 minutes followed by draining and refilling. Acetic acid is added over 5 minutes until the pH stabilizes to 6.5-7.0. The fabric is then treated for 10 minutes with a stabilized liquid catalase to neutralize any residual peroxide.

The fabric is rinsed, drained and dried.

Cotton yarns can be bleached effectively in a pressure dyeing machine. The pH of the bleach liquors can be easily adjusted to control the pH with soda ash. The bleach solution is automatically programmed to give alternate inside out and outside in of the yarn package in to insure bleach uniformity. The acetic acid rinse can be controlled to keep the cloth near neutral. This is followed by treatment with the catalase to remove residual peroxide and a final rinse.

Bleaching with Oxygen

The advantages of employing package dyeing equipment for the novel low temperature, low alkali bleaching system is essentially the same as that cited for the chlorine bleach systems via a finishing plant operation. During this dyeing process, pH control is maintained for the bleach system. The pH is continuously monitored through the add system of the package dyeing machine.

Bleaching with Chlorine

The fabric is padded to 100 percent wet pick up in a solution containing 0.2 g/l wetting agent and 1 gpl chlorine bleach at a pH of 7.5-8.0 and stored in a J Box for 20 minutes at room temperature. For highly discolored fabrics the temperature may be increased but may not exceed 40° C. For pH adjustments, soda ash is preferred because of its buffering effect and so the cloth will not need an acetic acid rinse to obtain a final pH of 6.8-7.2. An antichlor treatment with sodium bisulfite or sodium thiosulfate to remove any unreacted chlorine completes the bleaching process.

Fibers derived from raw cotton fiber (ecru) are bleached at less than 70° C., preferably at ambient or room temperature, with a bleaching solution comprising an OX⁻ system, where X is a halogen and where the pH is 6.5 to 8.

### Dyeing

The dye bath is set with the proper concentration of dye on the fabric, 1 gpl of antifoam, 1 gpl of a scouring agent and the salt concentration from Table 3. The temperature is raised to 60° C. and dye for 20 minutes. Soda ash (see Table 3) is added and dyeing continued for 40 additional minutes. The bath is dropped and the fabric is given a hot (60° C.) rinse containing 1 gpl acetic acid. The bath is dropped and the fabric soaped 10 minutes at 60° C. with 1 gpl of a washing agent followed by a hot (60° C.) rinse for 10 minutes and a cold rinse (20° C.) for 10 minutes. Treatment of cellulose containing fabrics continues after a standard preparation treatment.

Another method of chlorine bleaching is to employ package dyeing equipment. This method offers considerable advantages over continuous bleaching in a finishing plant. The pH of the process is continuously monitored via the add tank and corrections can be made while running. After the antichlor treatment, the yarn packages do not need to be dried but the dyeing operation can be started immediately. This bleach method can be employed on small runs in order to make and test product changes, for example, in the color line or for product modifications. Further, this method provides better shrinkage control of the yarns since normal shrinkage will have occurred during the package bleaching/dyeing process.

### EXAMPLE 2

A desized and bleached cotton print cloth (Testfabrics style 400 weighing 3.03 osy (oz/yd²)) was treated at 100 percent wet pickup with a solution of a 0.75 percent owf (on weight of fabric) emulsified candelilla wax, and 0.1 percent nonionic wetting agent. After drying, the fabric passed the 45° C. flammability test, (16 C.F.R. §1610, standard for the flammability of clothing textiles) and did not ignite even after a 4 second flame impingement.

### EXAMPLE 3

An army carded cotton sateen which had been desized and bleached (Testfabrics style 428 weighing 6.93 osy, and a bleached, mercerized, and carded cotton broad cloth (Testfabrics' style 453, weighing 3.53 osy) and a cotton sheeting (Testfabrics' style 493, weighing 4.45 osy) gave the same results (passed the 45° C. flammability test) after treating in the fabrics in the manner described above, (treated at 100 percent wet pickup with a solution of a 0.75 percent owf (on weight of fabric) emulsified candelilla wax, and 0.1 percent nonionic wetting agent).

### EXAMPLE 4

A spun Viscose challis (ISO-105/F02, Testfabrics style 266, weighing 4.07 osy) treated as above, did not ignite even after a four second flame impingement.

### EXAMPLE 5

A Cotton/Linen 56/44 blended fabric (Testfabrics' style L5040, weighing 6.4 osy) treated as above did not ignite even after a 4 second flame impingement. The same results were obtained when bees wax was substituted for the candelilla wax. The same results were obtained when a 50/50 emulsified blend of Jojoba and Carnauba was employed.

The desized and bleach print cloth (Testfabrics' style 400) cited above was treated with 1.0 percent blend (50/50 w/w) mixture of oleic and stearic acid at 75 percent wet pickup. After drying, fabric did not ignite even after a 4 second flame impingement. The ignition resistance protection did not occur after the fabric was laundered to remove the acid blend.

### EXAMPLE 6

The non-flammability and ignition resistance of the bi-regional cotton fibers impregnated with the phosphonium salt of the disclosure is determined following the test procedure set forth in 14 C.F.R. §25.853(b). The test is performed as follows:

A minimum of three 1 inch×6 inch×6 inch (2.54 cm×15.24 cm×15.24 cm) specimens (derived from a batting of the bi-regional cotton fibers as prepared above). The specimens are conditioned by maintaining them in a conditioning room maintained at a temperature of 70° C.±3° C. and 5 percent relative humidity for 24 hours preceding the test.

Each specimen is supported vertically and exposed to a Bunsen or Turill burner with a nominal I.D. tube of 1.5 inches (3.8 cm) in height. The minimum flame temperature is measured by a calibrated thermocouple pyrometer in the center of the flame and is 1550° F. (843° C.). The lower edge of the specimen is 0.75 inch (1.91 cm) above the top edge of the burner. The flame is applied to the cluster line of the lower edge of the specimens for 12 seconds and then removed.

Pursuant to the test, the material is self-extinguishing. The average burn length does not exceed 8 inches (20.32 cm), the average after flame does not exceed 15 seconds and flaming drippings did not continue to burn for more than 5 seconds after falling to the burn test cabinet floor. The test was repeated on a first material after 5 washings, on a second material after 10, on a third material after 25 washings, on a forth material after 35 washings, and on a fifth material after 50 washings. With each material, regardless of the number of washings, the material continued to pass the test with results similar to those of the first test. The tests were repeated multiple times with similar results.

In comparison, the test was conducted on regular non-bi-regional cotton fibers treated with phosphonium salt. While the regular cotton passed the test set forth in 14 C.F.R. §25.853(b) without washing, a second material was tested after five washes and had a burn length of less than 8 inches and therefore failed the tests. The tests were repeated multiple times with similar results.

### EXAMPLE 7

Ozone has been found to be effective in the de-colorization of dyes such as indigo (see Wasinger/Hall U.S. Pat. Nos. 5,313,811, 5,366,510 and 5,531,796). Ozone is also effective as a bleaching agent on desized and prepared goods in a finishing plant operation (see, Wasinger/Hall U.S. Pat. No. 5,376,143). Ozone may not have been used as a bleaching agent on raw cotton goods because the usual finishing plant preparation procedures involve the removal of the wax.

Raw cotton yarn can be bleached in a package dyeing machine using ozone without removal of the cotton wax to a degree of whiteness ranging from 75-85 (AATCC Method 110 “American Association of Textile Chemists and Colorists”) depending upon the time, ozone concentration and water temperature of the treatment. The so bleached goods were found to have retained almost all of its initial tensile strength along with an increase in the wet-ability of the goods without any measurable wax removal. After treatment, the package is ready for dyeing.

In a one pound Morton sample package dye machine, is added deionized water (pH 6.9-7.2 and 15-18° C.), 0.10 gpl Tergitol wetting agent owb that was circulate in and out through the yarn package for 5 minutes. Ozone from a ClearWater Tech (Model CD2000P) generator with a dry air flow and at a pressure of 10 psi was added continuously over 30-60 minutes depending upon the level of whiteness desired. The flow cycle was 5 minutes on the outside in and 5 minutes on inside out. After rinsing (two in-out cycles) twice with deionized water, the package was dried by the usual methods. If dyeing is to occur, the packages are already prepared and do not need to be pre-dried prior to the dyeing. Since the packages are wound in a loose state, normal shrinkage occurs and hence the shrinkage in the final garment is mitigated. Another advantage is that small lots can be evaluated for color and other properties without the need for long runs to produce enough fabric for full finishing machinery trials.

Ozone creates hydroxyl (OH⁻) radicals which although they are short lived at elevated temperatures are sufficiently stabile in cold water to effectively facilitate in the bleaching along with the ozone itself.

Additional advantages of this bleach system include the absence of BOD (biochemical oxygen demand) in the effluent; any bacteria or fungi in the cotton goods are also destroyed.

The use of the package machine is also useful for bleaching employing essentially the same low temperature process that is described for fabric bleaching. The advantage of this process is that the yarn is now ready for dyeing without a pre-drying step employed with fabric bleaching.

### EXAMPLE 8

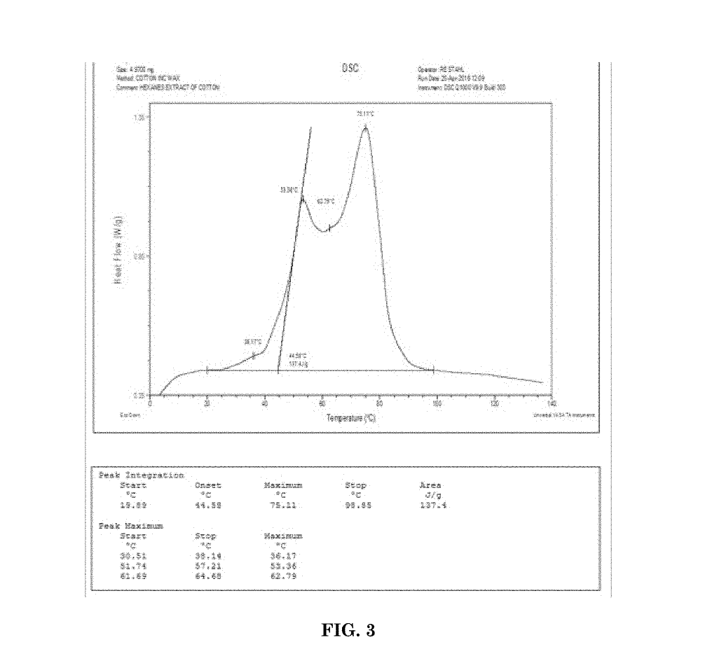

A preferred method of fireproofing and dying a fabric is shown in FIG. 2. The method 200 preferably starts with an unbleached cotton fabric at step 205. While cotton is the preferred fabric, the fabric can be of any material including but not limited to wool, nylon, polyester, hemp, silk, satin, other natural or artificial fibers, or combinations thereof. The fabric can be woven, non-woven, or knit. At step 210, the fabric is padded with a THPS (Tetrakis(methlyoxy)phosphonium Sulfate) solution (50% solids with non-ionic surfactant) for preferably 5 to 15 minutes. However, the padding can occur for more or less time for example 2 to 20 minutes or 1 to 30 minutes, or until the THPS solution penetrates the cellulous portion of the fiber in the fabric. The padding is preferably applied a room temperature; however, the padding may be applied at above or below room temperature. The solution may be another phosphonium salt, or another fire retardant or fireproofing solution. Phosphonium salts typically leave an unpleasant odor on the fabric and is toxic to factory workers during application or other usage of the phosphonium salts. It has been surprisingly discovered that by adding a small amount of orange or lemon oil (D-Lemonene) to the solution neutralizes the odor and toxicity. For example, 4 oz of orange oil can be added to 20 g of solution to neutralize the odor from the phosphonium salt. However, more or less orange oil can be added, for example 2 oz, 3 oz, 5 oz, or 6 oz.

At step 215, the fabric is washed to remove excess THPS. Preferably the fabric is washed with water, however the washing may occur with soaps, alcohols, acids, basis, or other liquids. The fabric is set in step 220. Preferably, the setting occurs in an oven at 150° C. for 5 to 25 minutes. The setting may occur at higher or lower temperatures (for example 100° C., 125° C., 175° C., or 200° C.) and for more or less time (for example 3 to 30 minutes, 2 to 45 minutes, or 1 to 60 minutes). Preferably, at step 225, the fabric is washed a second time. The second wash preferably is at room temperature with an aqueous solution of ozone. For example, the ozone wash preferably occurs at between 15 and 25° C., and more preferably at about 20° C. In traditional “low temperature bleach” (LTB) processes, the wash must be heated to at least 60° C. The second wash preferably simultaneously sets the THPS in the cellulous portion of each fiber and bleaches the fibers without removing any natural wax coatings of the fibers. In some cases, the odor from the phosphonium salt returns after washing. Preferably, adding bleach and additional orange oil to the wash permanently neutralizes the odor by oxidizing the contaminants without affecting the final fiber.

At step 230, the fabric is preferably dyed. The fabric can be dyed any color, pattern, or combination thereof. Preferably, the dye is selected from reactive or direct dyes and is allowed to remain in contact with the fabric for 5 to 30 minutes, 2 to 45 minutes, or 1 to 60 minutes. The dying step is shown as occurring after the ozone washing step, however the dying step may occur at any point in the process. Excess dye is washed from the fabric at step 235 and a step 240 the fabric is allowed to dry, for example on a pin frame.

While the steps are described in a specific order, the process may occur in another order, for example the fiber may be converted into a bi-regional fiber first, then dyed, and then treated with the phosphonium salts. Washing, heat setting and oxidizing may be implemented as necessary.

Other embodiments and uses of the invention will be apparent to those skilled in the art from consideration of the specification and practice of the invention disclosed herein. All references cited herein, including all publications, and all U.S. and foreign patents and patent applications are specifically and entirely incorporated by reference. The term comprising, where ever used, is intended to include the terms consisting and consisting essentially of. Furthermore, the terms comprising, including, and containing are not intended to be limiting. It is intended that the specification and examples be considered exemplary only with the true scope and spirit of the invention indicated by the following claims.

1. A flame retardant bi-regional fiber, comprising:
a cotton fiber cellulosic center impregnated with a flame suppressant; and
an outer surface comprised of natural cotton wax from the cotton fiber;
wherein the average char length of the flame retardant bi-regional fiber is less than 0.5 inches.

2. The bi-regional fiber of claim 1, wherein the fiber is bleached.

3. The bi-regional fiber of claim 2, wherein the fiber is bleached with chlorine, ozone, peroxide, hypochlorite or a combination thereof.

4. The bi-regional fiber of claim 1, wherein the flame suppressant is a phosphonium solution or a carbon solution.

5. The bi-regional fiber of claim 1, wherein the wax comprises at least 0.4 percent by weight of said fiber.

6. The bi-regional fiber of claim 1, wherein the wax comprises from about 0.4 percent to about 25 percent by weight of said fiber.

7. The bi-regional fiber of claim 1, wherein the wax comprises about 14 percent to about 16 percent by weight of said fiber.

8. The bi-regional fiber of claim 1, which has at least 10 percent greater tensile strength and/or abrasion resistance as compared to natural cotton fibers.

9. The bi-regional fiber of claim 1, which has at least 20 percent greater tensile strength and/or abrasion resistance as compared to natural cotton fibers.

10. The bi-regional fiber of claim 1, further comprising applying a saponified acid or derivative thereof to the outer surface of the fiber.

11. The bi-regional fiber of claim 10, wherein the saponified acid or derivative thereof comprises lauric acid, myristic acid, palmitic acid, stearic acid, oleic acid or combinations thereof.

12. The bi-regional fiber of claim 1, wherein the char length is determined according to at least one of FAR 25.853(b) or 16 CFR Parts 1615 and 1616.

13. The bi-regional fiber of claim 1, wherein the char length is maintained after 50 washes.

14. The bi-regional fiber of claim 1, wherein the char length is maintained after 100 washes.

15. The bi-regional fiber of claim 1, which has reduced water absorption as compared to a natural cotton fiber.

16. A textile comprised of a plurality of the bi-regional fibers of claim 1.

17. The textile of claim 16, which is at least one of fire retardant and ignition resistant.

18. The textile of claim 17, wherein the char length is maintained after 50 washes.

19. The textile of claim 17, wherein the char length is maintained after 100 washes.

20. The textile of claim 16, which has reduced water absorption as compared to a natural cotton fiber.

21. The textile of claim 16, which has a wrinkle resistance greater than conventional cotton.

22. The textile of claim 16, further comprising additional fibers.

23. The textile of claim 22, wherein the additional fibers comprise natural fibers, synthetic fibers, carbonaceous fibers, and combinations thereof.

24. The textile of claim 23, wherein the synthetic fibers comprise polyester.

25. The textile of claim 23, wherein the synthetic fibers comprise about 50 to about 90 percent polyester and about 10 to about 50 percent bi-regional fibers.

26. The textile of claim 23, wherein the carbonaceous fibers are flexible bi-regional carbonaceous fibers.

27. The textile of claim 16, wherein the textile is formed into apparel for infants, toddlers, children or adults.

28. The textile of claim 27, wherein the apparel comprises shirts, socks, pants, sweaters, sweats, gators, hats, scarves, coats, undergarments, sportswear, skirts, dresses, tops, blankets, and designs and combinations thereof.

29. The textile of claim 27, wherein the apparel is suitable for wear in environments where conditions are greater than and/or less than body temperature.

30. A method of manufacturing a bi-regional flame retardant fiber, comprising the steps of:
padding a fiber with a flame suppressant;
setting the flame suppressant into the fiber in an oven;
washing the set fiber with an aqueous solution of ozone to make the flame suppressant insoluble; and
drying the fiber.

31. The method of claim 30, further comprising dying the fiber.

32. The method of claim 30, wherein the flame suppressant is a phosphonium salt.

33. The method of claim 32, further comprising adding orange oil to the phosphonium salt.

34. The method of claim 30, further comprising adding orange oil and bleach to the aqueous solution of ozone.

35. The method of claim 30, wherein the step of washing the set fiber with an aqueous solution of ozone is conducted at room temperature.

36. The method of claim 32, wherein the phosphonium salt is a THPS (Tetrakis(methlyoxy)phosphonium Sulfate) solution.

37. The method of claim 30, wherein the fiber is cotton.

38. The method of claim 30, further comprising at least one of weaving the fiber into a fabric, knitting the fiber, and processing the fiber in a non-woven or textile manufacturing process.

39. The method of claim 30, wherein the fiber is a bi-regional fiber comprising:
a cotton fiber cellulosic center impregnated with phosphonium salt; and
an outer surface comprised of natural cotton wax from the cotton fiber;
wherein the average char length of the flame retardant bi-regional fiber is less than 0.5 inches.

40. The method of claim 38, wherein the char length is determined according to at least one of FAR 25.853(b) or 16 CFR Parts 1615 and 1616.
